(19) United States
(12) Patent Application Publication
(10) Pub. No.: US 2010/0094456 A1
(43) Pub. Date: Apr. 15, 2010

(54) DEVICES AND METHODS FOR PROVIDING CASHLESS PAYMENT AND DIAGNOSTICS FOR VENDING MACHINES

(75) Inventors: Joseph Simpkins, West Chester, PA (US); Cary Sagady, Chester Springs, PA (US)

Correspondence Address: RATNERPRESTIA, P.O. BOX 980, VALLEY FORGE, PA, 19482, US

(73) Assignee: USA Technologies, Inc., Malvern, PA (US)

(21) Appl. No.: 12/249,163

(22) Filed: Oct. 10, 2008

(51) Int. Cl. G07F 9/02; G06F 17/00; G07F 7/00

(52) U.S. Cl. 700/236; 700/244

(57) ABSTRACT

A peripheral device for a vending machine, a method of communicating with a vending machine, a vending system, and a computer readable storage medium including software that is adapted to control a computer to implement a method of communicating with a vending machine are provided. The peripheral device includes a bus interface and a processor coupled to the bus interface. The peripheral device, via the bus interface, receives data from a bus and transmits data onto the bus. The processor enables cashless payment and provides diagnostic information for at least one other peripheral device of the vending machine based on data received from the at least one other peripheral device via the bus interface.

### FIELD OF THE INVENTION

The present invention relates to the field of vending and, more particularly, to devices and methods for providing cashless payment and diagnostic information for vending machines.

### BACKGROUND OF THE INVENTION

Vending machines are often used to vend items and/or services to consumers in locations where it would be impractical or inefficient to staff human beings to provide the items/services. Because vending machines are typically located where the vendor cannot constantly monitor their operations, vendors rely on operation information stored by the vending machines in the vending machines' memory, such as diagnostic information for peripheral devices (e.g., coin acceptors/changers and bill validators/acceptors). A Digital Exchange (“DEX”) interface is the current industry standard for gathering stored information by a vending machine.

### SUMMARY OF THE INVENTION

The present invention is embodied in a peripheral device for a vending machine, a method of communicating with a vending machine, a vending system, and a computer readable storage medium including software that is adapted to control a computer to implement a method of communicating with a vending machine. The peripheral device may include a bus interface and a processor coupled to the bus interface. The bus interface may receive data from a bus and transmit data onto the bus. The processor may enable cashless payment for the vending machine and provide diagnostic information for at least one other peripheral device based on data received from the at least one other peripheral device via the at least one bus interface over the bus. The peripheral device may also include a transmitter, which may transmit cashless payment information and diagnostic information to a remote processing unit.

### BRIEF DESCRIPTION OF THE DRAWINGS

The invention is best understood from the following detailed description when read in connection with the accompanying drawings, with like elements having the same reference numerals. When a plurality of similar elements is present, a single reference number may be assigned to the plurality of similar elements with a small letter designation referring to specific elements. When referring to the elements collectively or to a non-specific one or more of the elements, the small letter designation may be dropped. Included in the drawings are the following figures:

FIG. 1 is a block diagram of a vending system according to an exemplary embodiment of the present invention;

FIG. 2 is a block diagram of a cashless payment with diagnostics unit according to an exemplary embodiment of the present invention;

FIG. 3 is a flow chart of a method of communicating with a vending machine having a vending machine controller according to an exemplary embodiment of the present invention;

FIG. 4 is a block diagram of a cashless payment with diagnostics unit according to an exemplary embodiment of the present invention;

FIG. 5 is a flow chart of a method of communicating with a vending machine having a vending machine controller according to an exemplary embodiment of the present invention;

FIG. 6 is a circuit diagram of the cashless payment with diagnostics unit of FIG. 4 according to an exemplary embodiment of the present invention; and

FIG. 7 is a block diagram showing communication between a cashless payment with diagnostics unit and a remote processing unit according to an exemplary embodiment of the present invention.

### DETAILED DESCRIPTION OF THE INVENTION

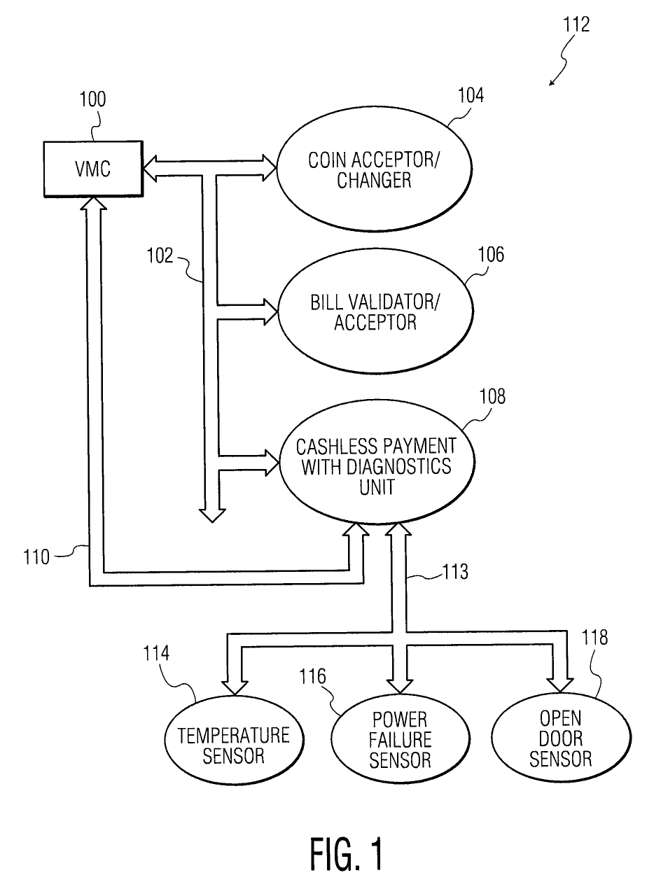

FIG. 1 is a block diagram of a vending system 112 for use in a vending machine according to an exemplary embodiment. The illustrated vending system 112 includes a first bus 102, a second bus 110, a vending machine controller (“VMC”) 100, a coin acceptor/changer 104, a bill validator/acceptor 106, and a cashless payment with diagnostics unit (“CPD”) 108. The vending system 112 may additionally include other devices, such as sensors that sense a parameter associated with the vending machine (referred to herein as “vending machine sensors”). Example vending machine sensors may include a temperature sensor 114, a power failure sensor 116 (e.g., a power relay), and/or an open door sensor 118 (e.g., a proximity switch), which are described in further detail below. These devices may communicate with the CPD 108 via a separate connection 113 and/or via the busses 102/110. Suitable buses, VMCs, coin acceptors/changers, and bill validators/acceptors will be understood by one of ordinary skill in the art from the description herein.

In one embodiment, the first bus 102 is a multi-drop bus (“MDB”). The bus 102, however, may be any other type of bus suitable for use in a vending system including, for example, a universal serial bus (“USB”) or an executive bus. The second bus 110 may include, for example, DEX interfaces, systems and infrastructure (hereinafter collectively referred to as “DEX”). The second bus 110 is not necessary for overall operation of the vending system 112 and may be omitted from the vending system 112 in some embodiments (e.g., if the bus 102 provides all necessary information to the CPD 108). In an exemplary embodiment, the MDB and the DEX operate in accordance with the National Automatic Merchandising Association (NAMA) Multi-Drop Bus/Internal Communication Protocol (MDB/ICP) version 3.0 and the European Vending Association (EVA) Data Transfer Standard (DTS) version 6.1, respectively, each of which are incorporated fully herein by reference.

The coin acceptor/changer 104, the bill validator/acceptor 106 and the CPD 108 are examples of VMC 100 “peripheral devices,” one or more of which may be included in the vending system 112. The peripheral devices are not intended to be limited to the examples shown in FIG. 1, however, and may include one or more of a multitude of other vending peripheral devices (e.g., sensors). The coin acceptor/changer 104, the bill validator/acceptor 106 and the CPD 108 are components which enable a user to pay for items in a vending machine. By way of example, the coin acceptor/changer 104 may accept coins and provide change where required, the bill validator/acceptor 106 may accept and validate paper currency, and the CPD 108 may accept credit cards, debit cards, gift cards and other forms of non-currency payment (“cashless payment”) via a card acceptor (not shown). The CPD 108 may also communicate with external resources/devices, for example, to obtain pre-authorizations and transmit payment requests.

The VMC 100 is a controller for the vending machine and, as such, controls functions of the vending machine. One such function is a data gathering function. In an exemplary embodiment, the VMC 100 performs the data gathering function by generating/issuing an information command requesting information from a particular peripheral device, addressing it to the particular peripheral device, and placing it on the bus 102. Each peripheral device receives and processes the information command to determine whether the command is addressed to that peripheral device (e.g., by parsing a header associated with the command to identify a destination address for the command). If the information command is addressed to the peripheral device that is processing the command, that peripheral device responds to the command (e.g., with a message). The VMC 100 then receives and stores the response (or “data”). The stored data from the VMC 100 may be retrieved manually via DEX (e.g., over the bus 110). DEX interfaces, systems and infrastructure, however, are complex and expensive. Further, data retrieved via DEX is typically only retrieved periodically (e.g., once per day). Accordingly, it may be desirable to not use DEX at all or to use DEX in combination with MDB data in order to more quickly collect and disseminate diagnostic data. In addition, it may be desirable to collect diagnostic data not available via DEX, such as the real-time state of a peripheral device, for example.

As described above, the CPD 108 is configured to communicate with external devices. The embodiments of the present invention described herein take advantage of this feature of the CPD 108. More specifically, the CPD 108 is configured to intercept and store responses (or data) sent by peripheral devices to the VMC 100 and to transmit the responses to a remote location, thereby eliminating the need for the VMC 100 to transmit the diagnostic communications using the DEX interface 110. Alternatively, MDB and DEX data may both be used to more quickly collect and disseminate diagnostic data while preserving the ability to use potentially useful DEX data to diagnose the vending system (e.g., information regarding columns being empty, how many times the door opens and temperature readings).

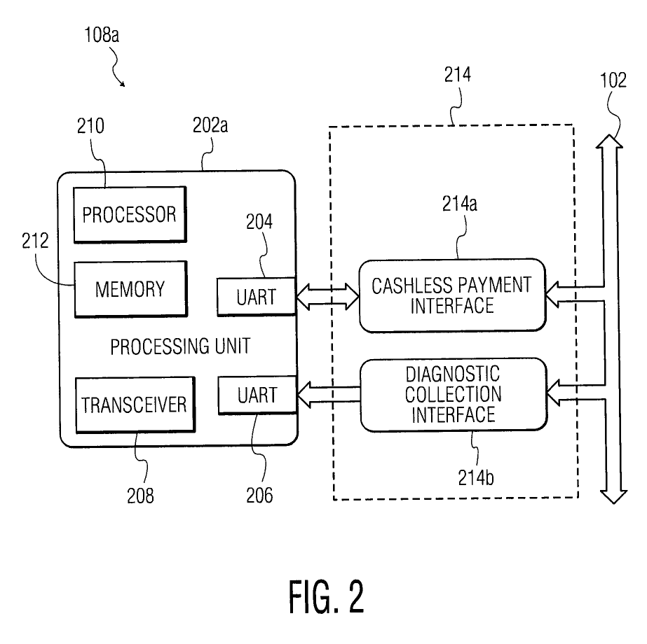

FIG. 2 is a block diagram of an exemplary CPD 108a. The illustrated CPD 108a includes a processing unit 202a and a bus interface 214. The illustrated processing unit 202a includes a processor 210, a memory 212, a transceiver 204 for communicating bi-directionally with the bus 102 via the bus interface 214, a transceiver 206 for receiving communications from the bus 102 via the bus interface 214, and a transceiver 208 for communicating bi-directionally with devices external to the vending machine in which the vending system 112 is used. The CPD 108 may also include, for example, a card reader, a display, a contactless (e.g., RFID) card reader and other devices (not shown). The transceivers 204 and 206 may each be a universal asynchronous receiver/transmitter (“UART”). The transceiver 208 may be a conventional wired or wireless device configured for communicating via a network, e.g., cellular, telephone, or global information network (Internet). Other suitable transceivers will be understood by one of skill in the art from the description herein.

The illustrated bus interface 214 includes a cashless payment interface 214a and a diagnostic collection interface 214b. In an exemplary embodiment, the cashless payment interface 214a is used by the processing unit 202a to provide cashless payment functionality for the vending machine and the diagnostic collection interface 214b is used to monitor the bus 102 for response communications sent by other peripheral devices.

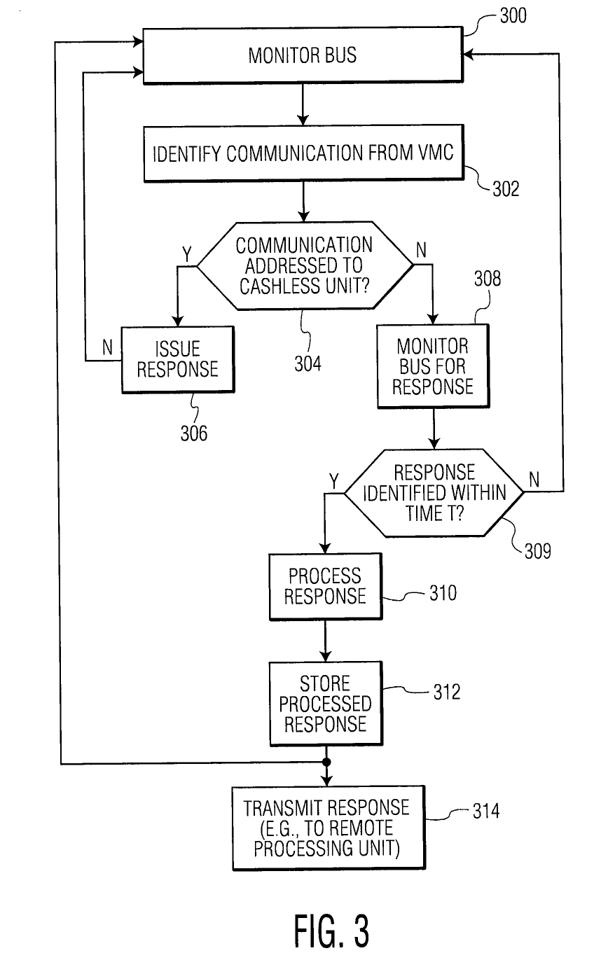

FIG. 3 is a flow chart of exemplary steps for performing the information gathering function. In an exemplary embodiment, the CPD 108a performs the information gathering function described with respect to FIG. 3.

In step 300, a vending bus is monitored. In an exemplary embodiment, the CPD 108a continuously monitors the bus 102 for communications (e.g., diagnostic information queries/responses) from/to the VMC 100. The bus 102 may be continuously monitored for all communications placed on the bus 102. More specifically, the cashless payment interface 214a, under control of the processor 210 within the processing unit 202a, may monitor the bus 102 for communications sent by the VMC 100 using the transceiver 204.

In step 302, a communication from the VMC 100 is identified. In an exemplary embodiment, the CPD 108a identifies the communication from the VMC 100. In an embodiment in which a MDB is used as the bus 102, the VMC 100 places all communications on the bus 102, and the communications are received by all peripheral devices connected to the bus 102. Thus, when the VMC 100 places a communication on the bus 102, the CPD 108a receives it, thereby identifying the communication from the VMC 100. More specifically, when a communication is sent by the VMC 100, the cashless payment interface 214a may pass the communication via the transceiver 204 to the processing unit 202a for identification. When a MDB is used as the bus 102, the processing unit 202a may receive all communications placed by the VMC 100 on the bus 102 and then parse out the addressee of the communication.

In decision block 304, a determination is made as to whether the communication is addressed to the CPD 108a. In an exemplary embodiment, the processor 210 within the processing unit 202a determines whether the communication is addressed to the CPD 108a. The processing unit 202a may determine whether the communication is addressed to the CPD 108a by reading the address of the communication from the VMC 100. When a MDB is used as the bus 102, communications from the VMC 100 are addressed to the peripheral device from which the VMC 100 requires a response. Thus, by reading the address line, the processing unit 202a may determine whether the communication is addressed to the CPD 108a or to another peripheral device.

If the communication is addressed to the CPD 108a, in step 306, a response is issued. In an exemplary embodiment, the processing unit 202a issues a response to the VMC 100 via the UART 204, the cashless payment interface 214a, and the bus 102. The response may include information that the VMC 100 has requested.

If the communication is not addressed to the CPD 108a, in step 308, the bus is monitored to identify a response. In an exemplary embodiment, the processing unit 202a controls the diagnostic collection interface 214b to monitor the bus 102 for a response to the communication from another peripheral device using UART 206 (e.g., from a peripheral device that is not the CPD).

In decision block 309, whether a response is received within a defined time t is determined. In an exemplary embodiment, the CPD 108a identifies the response by monitoring the bus 102 for a response to the communication sent by a peripheral device, which is expected within a defined period of time t (e.g., 5 ms). In an embodiment in which the MDB is used as the bus 102, when the VMC 100 places a communication on the bus 102, the VMC 100 addresses the communication to a peripheral device from which it requires a response. Thus, when the CPD 108a receives the identified communication, it is able to determine from the address which peripheral device is expected to respond. If a response is not received within time t, the process returns to the monitoring step 300 so that further communications that the VMC 100 places on the bus 102 are not missed. If a response is received within time t, the process continues to step 310.

In step 310, the received response is processed. In an exemplary embodiment, the processing unit 202a performs the processing steps. The received response may indicate that the peripheral device is in an abnormal state (e.g., it is out of money, jammed, etc.). Here, the processing may simply include associating an identifier with the response. The identifier may relate to, for example, the peripheral device that sent the response and/or the time the response was received, or may be any arbitrary identifier. The response may, however, provide a more specific indication (e.g., there are 5 quarters left for dispensing from the coin acceptor/changer 104). Here, additional processing/analyzing of the response may be performed. For example, the number of quarters left for dispensing from the coin acceptor/changer 104 may be compared against a threshold number. If the number of coins left is less than or equal to the threshold number, an event is triggered. The event may be the generation of a processed/analyzed response indicating that service is needed to fill the coin acceptor/changer 104 with additional coins, for example.

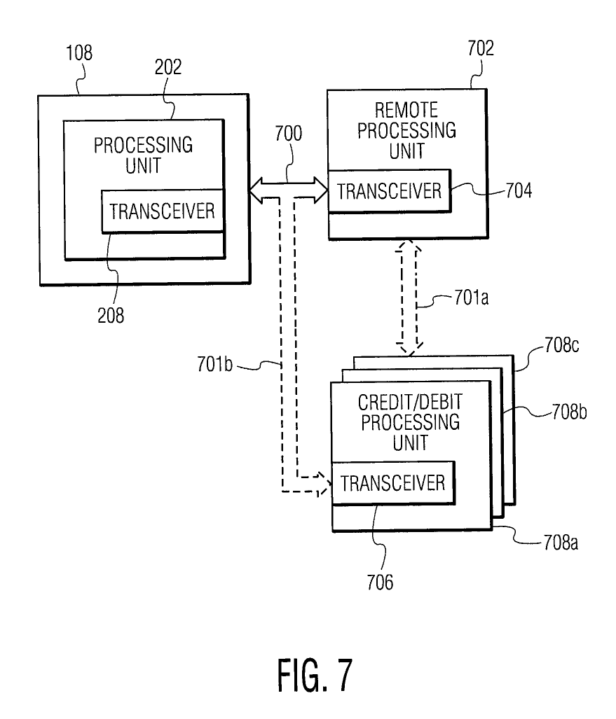

The processing performed in step 310 may include analyzing the received response to determine a level of priority. For example, each response may be assigned a low, medium or high level of priority. By way of example, a response indicating that the number of coins remaining in the vending machine for providing change is low may be assigned a lower priority than a response indicating that the vending machine is completely empty of coins for providing change. As described in further detail below, the assigned priority level may be used to determine how quickly the problem is reported (e.g., how quickly the analyzed response is transmitted to a remote processing unit such as remote processing unit 702 in FIG. 7).

In step 312, the response is stored, which may be the received response or a processed/analyzed response based on the received response. In an exemplary embodiment, the processing unit 202a stores the response with the associated identifier in memory 212. When the received response provides the more specific indication, data corresponding to the processed/analyzed response may be stored in the memory 212 if the event is triggered along with an associated identifier. Here, when the event is not triggered, the processed response may not be stored because it does not indicate that any action needs to be taken with respect to the vending machine. For example, if the number of coins remaining in the coin acceptor/changer is greater than the threshold, the coin acceptor/changer 104 does not require additional coins. After the processed response is stored in step 312, processing returns to step 300 and may proceed to step 314.

In step 314, the response(s) is/are transmitted. In an exemplary embodiment, the transceiver 208 transmits the response(s) to an external device (e.g., a remote processing unit from which a user may collect the transmitted data within a relatively short period of time of its transmission and, accordingly, know shortly after the vending machine malfunctions to send someone out to fix or replenish the vending machine). The response(s) may be transmitted over, for example, a global information network (e.g., the Internet), intranet, satellite system, telephone system, or other suitable communication system. Transmitting step 314 may occur at different times after completion of storing step 312, and the different times may be customizable. By way of example, processed responses may be transmitted immediately after they are stored (e.g., responsive to storing the processed response or after a very short time period such as 5 ms). By way of another example, the processed responses may be scheduled for periodic/calendar-based transmittal (e.g., once every hour, day, week, etc.), scheduled for transmittal at set times of day (e.g., every day at 6 o'clock PM), or scheduled for interval transmittal (e.g., fixed time since last transmittal). As described above, some or all of the processed responses may be assigned priority levels during processing step 310. Here, the timing of the transmissions may depend on the assigned priority level. For example, high priority responses may be sent immediately and low priority responses may be sent daily.

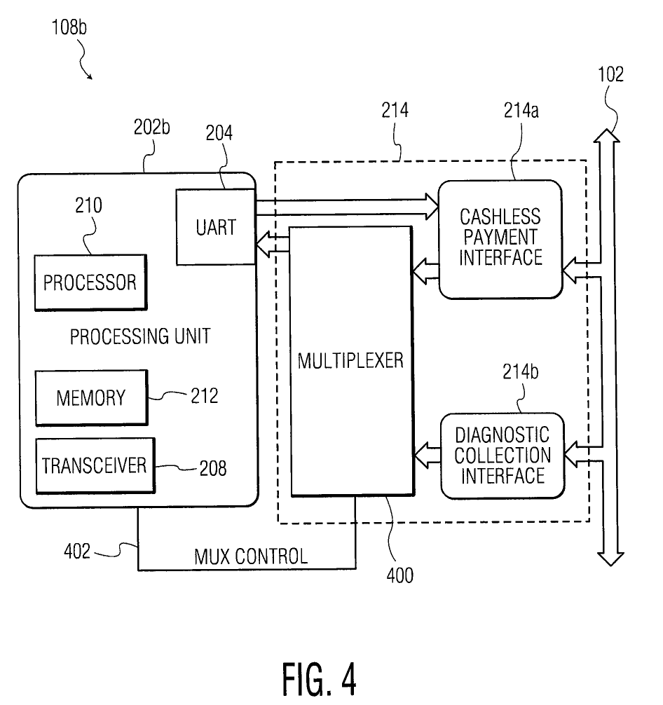

FIG. 4 is a block diagram of an alternative exemplary CPD 108b. The illustrated CPD 108b includes a processing unit 202b and a bus interface 214. The illustrated processing unit 202b includes the UART 204 and the transceiver 208. The illustrated bus interface 214 includes the cashless payment interface 214a, the diagnostic collection interface 214b and a multiplexer 400. The processing unit 202b controls the multiplexer 400 using at least a multiplexer control line 402. As shown in FIG. 4, the CPD 108b is similar to the CPD 108a, except the processing unit 202b uses only one UART (204), which is configured to transmit data to the cashless payment interface 214a and receive data from either the cashless payment interface 214a or the diagnostic collection interface 214b via the multiplexer 400. It will be understood that other UARTs (not shown) may be present for other uses.

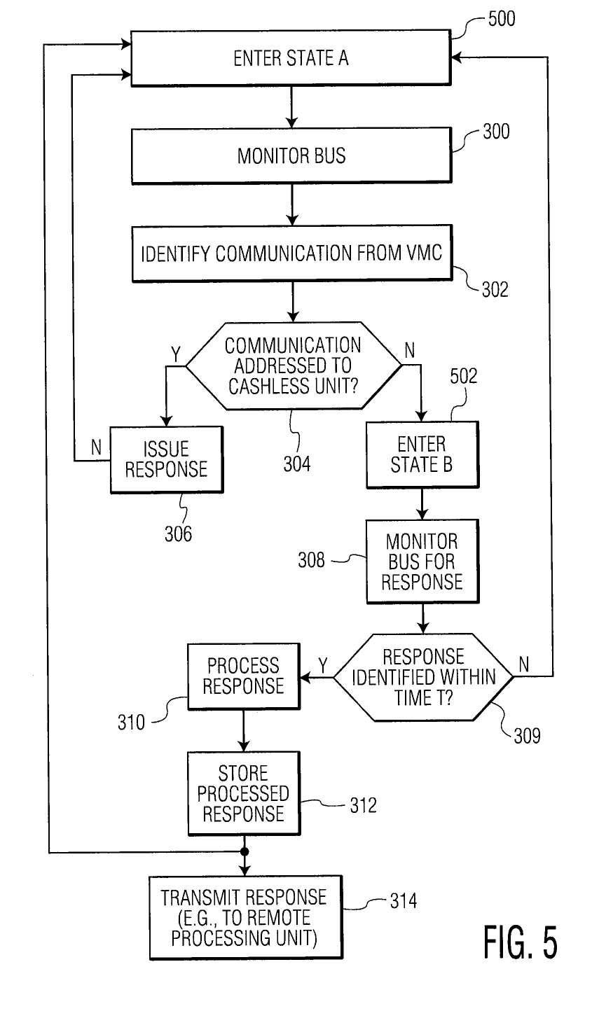

FIG. 5 is a flow chart of exemplary steps for performing the information gathering function using a multiplexer (e.g., multiplexor 400 in FIG. 4). In an exemplary embodiment, a state machine is implemented using either software (e.g., implemented by processor 210) or hardware included in the processing unit 202b, with the state machine governed in accordance with MDB protocol.

The illustrated flow chart includes two states of operation (i.e., state A, which is entered in step 500, and state B, which is entered in step 502). In state A, the multiplexor 400 is selected to listen to the bus 102 via cashless payment interface 214a for communications sent by the VMC 100 (step 300). If a valid message is sent by the VMC 100 while in state A, the message is received by the processing unit 202b via UART 204 (step 302). In decision block 304, the processing unit 202b determines whether the received message is addressed to the CPD 108b. If it is, a response is issued in step 306 and the state machine returns to state A. If not, the state machine enters state B in step 502. Steps 300, 302 and 306 and decision block 304 are the same as the corresponding steps/decision block in FIG. 3.

In state B (step 502), the multiplexor 400 is selected to listen to the bus 102 via diagnostic collection interface 214b for response communications from the peripheral devices (step 308). If a valid response message is sent by a peripheral device while in state B and within a defined time t (decision block 309), the message is received by the processing unit 202b via UART 204. The received message is then processed (step 310) and stored (e.g., in memory 212; step 312). After the processed response is stored, the state machine re-enters state A. The stored response may then be transmitted in step 314 as described above with respect to corresponding step 314 of FIG. 3. If it is determined that no response message is received within the defined time in decision block 309, a timeout may occur and state A may be re-entered. Steps 308, 310, 312 and 314 and decision block 309 are the same as the corresponding steps/decision block in FIG. 3.

In an exemplary embodiment, when a valid communication is received from the VMC 100 and the communication is addressed to the CPD 108b, the CPD 108b responds in accordance with the MDB specification and, in parallel, properly configures the state machine. Messages are received and stored for parsing and extraction of useful diagnostic information (e.g., using software at the remote processing unit of FIG. 7).

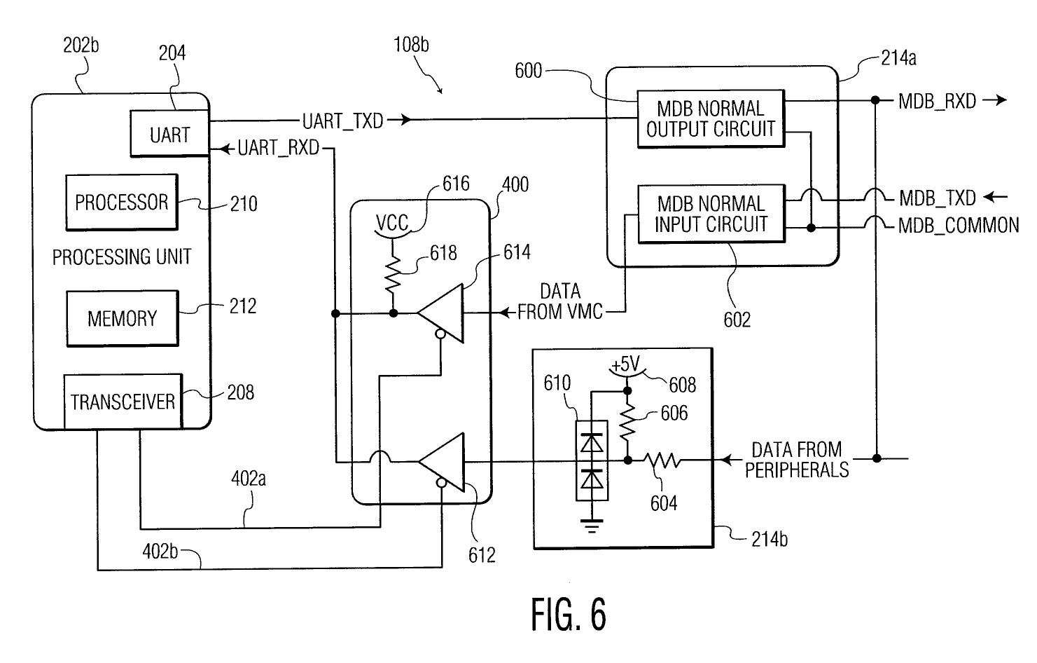

FIG. 6 is a circuit diagram showing exemplary circuitry for use with processing unit 202b (FIG. 4). The exemplary circuitry includes circuitry for MUX 400, cashless payment interface 214a and diagnostic collection interface 214b.

The illustrated circuitry for multiplexer 400 includes two logic integrated circuits (“ICs”) 612 and 614. The illustrated ICs are 74LCX125 logic units. Other suitable logic units will be understood by one of skill in the art from the description herein. The IC 614 is coupled to a resistor 618 and a supply voltage VCC 616. The resistor 618 may be a 10K resistor. IC 614 is configured to receive data from the VMC 100 and IC 612 is configured to receive data from the other peripheral devices.

In an exemplary embodiment, the diagnostic collection interface 214b includes a dual diode 610, resistors 604 and 606, and power supply 608, as illustrated. The dual diode 610, which may be a BAV99 dual diode, protects the IC 612. The resistor 606, which may be a 470K-ohm resistor, provides weak pull-up. The resistor 604, which may be a 47K-ohm, resistor, isolates the load of the IC 612, the dual diode 610 and the resistor 606 from the bus 102. This circuitry allows the diagnostic collection interface 214b to receive and condition responses from the VMC placed on the bus 102.

As described above with respect to FIG. 4, processing unit 202b controls the multiplexer 400 to transfer either data from the VMC 100 or data from the other peripheral devices to the processing unit 202b. The illustrated processing unit 202b controls the MUX 400 to transfer either data from the VMC 100 or from the other peripheral devices by turning on one of the ICs 612 and 614 using MUX control line 402a or 402b, respectively. Thus, when data from the VMC 100 is to be transferred, the processing unit 202b may apply a voltage to IC 614 and when data from the peripherals is to be transferred the processing unit may apply a voltage to IC 612. In an exemplary embodiment, the applied voltage is a logic low voltage (e.g., 0V).

The illustrated cashless payment interface 214a includes a MDB normal output circuit 600 and a MDB normal input circuit 602. Exemplary MDB normal output circuits and MDB normal input circuits according to MDB protocol are well known in the art. The illustrated MDB normal output circuit 600 is configured to receive information from the UART 204. The illustrated MDB normal input circuit 602 is configured to transmit data to the IC 614.

FIG. 7 is a block diagram of a communication system according to an exemplary embodiment. As described above, the processing unit 202 of the CPD 108 includes a transceiver 208 for communicating with remote devices external to the vending system 112. Such external devices may include, for example, a remote processing unit 702 and one or more credit/debit processing unit(s) 708a, 708b, and/or 708c, such as shown in FIG. 7. The remote processing unit 702 may be included in, for example, a computer at a vendor's office, at the vending machine manufacturer's office or at another location where it may be desirable for vending machine diagnostic information to be received, stored and/or analyzed. The credit/debit processing unit(s) 708 may be included, for example, in a computer(s) in a credit card company office, debit card company office, bank, or office of other agencies offering credit/debit. The remote processing unit 702 and the credit/debit processing unit(s) 708 may include transceivers 704 and 706, respectively.

In FIG. 7, the arrows represent a communication network 700 and optional communication networks 701a and b. Communication network 700 permits at least unidirectional communication between the processing unit 202 and the remote processing unit 702. Optional communication network 701a permits at least unidirectional communication between the processing unit 202 and the remote processing unit 702 and/or between the remote processing unit 702 and the credit/debit processing unit(s) 708. The network may include, for example, an intranet, a satellite system, a telephone system, a global information network (e.g., the Internet) or any other suitable communication system.

In an exemplary embodiment, all communication with the credit/debit processing unit 708 occurs via remote processing unit 702, in which case communication network 701b may be omitted. In such an embodiment, to establish communication with the credit/debit processing unit 708, the CPD 108 first sends the communication to the remote processing unit 702. The remote processing unit 702 may perform processing on the communication (e.g., combining it with other communications destined for the credit/debit processing unit 708). Then, with or without processing, the remote processing unit 702 transmits the communication to the credit/debit processing unit 708. In an alternative exemplary embodiment, the CPD 108 may transmit communications directly to the credit/debit unit 708, thereby bi-passing the intermediary remote processing unit 702.

During the cashless vending operation of the CPD 108, when the CPD 108 receives a request from a user to pay for an item using credit/debit (e.g., by inserting a credit/debit card into the card reader (not shown) of the CPD), the transceiver 208 may transmit a request to the appropriate credit/debit processing unit 708 to authorize a credit/debit amount. As described above, the request may be sent either through the remote processing unit 702, which acts as an intermediary, or may be sent directly to the appropriate credit/debit processing unit 708. Upon receipt of the request by the appropriate credit/debit processing unit 708 via the transceiver 706, the transceiver 706 may transmit a response to the processing unit 202 either approving or denying the authorization request. Again, the processing unit 708 may transmit the response either indirectly through the remote processing unit 702 or directly to the credit/debit processing unit 708.

During the information gathering function of the CPD 108, the CPD 108 may upload the stored data to the remote processing unit 702. The uploading may occur, for example, at different times as described above with respect to step 314 in FIG. 3. To upload the data, the processing unit 202 may simply transmit the data using the transceiver 208 to the remote processing unit 702, which receives the data via the transceiver 704 and stores it in a memory (not shown). Thus, the vending system 112 may use the transceiver already included in the CPD 108 to transmit diagnostics data to a remote processing unit. And the vending system 112 uses capabilities of the vending system 112 to carry out multiple functions, thereby providing an efficient alternative to using a DEX interface to gather data from a vending machine including the vending system 112.

In an exemplary embodiment, the information gathering function includes gathering diagnostic information from the other peripheral devices. Such information may include, for example, whether the coin acceptor/changer unit 104 or the bill validator/acceptor unit 106 is empty or full of currency and whether other peripheral device(s) are operating properly (e.g., whether there is a bill acceptor jam). The ability to efficiently transfer diagnostic information to an external device facilitates inexpensive and relatively easy review of the information, thus enabling more immediate attention to diagnostic data that requires a response.

In another exemplary embodiment, the information gathering function includes gathering diagnostic information from vending machine (VM) sensors other than “other peripheral devices.” Here, the CPD 108 may gather diagnostic information such as temperature readings from VM temperature sensor(s) 114 (e.g., a thermistor(s)) located at one or more locations within the vending machine, interruptions in power being supplied to the vending machine from external VM power failure sensor(s) 116 (e.g., a power relay(s)) and whether the vending machine's door is open from VM open door sensors 118 (e.g., a proximity switch(es)). Use of the CPD 108 with temperature sensors, power failure sensors and open door sensors, for example, may quickly and remotely provide important information to an owner/operator of the vending machine. Such information may include whether the temperature in the device has dropped below desirable or safe operating levels, whether power to the device has been compromised and whether a reach-in vending machine's door has been left open, thereby enabling a quick response to emergency conditions to, for example, remove spoiled product from the machine or to fix the vending machine before the product spoils. This may be especially useful in applications such as vending machines that dispense or store frozen or spoilable food product.

The CPD 108 may also be configured to transmit payment requests to the remote processing unit 702. This may be useful, for example, so that one entity may compile and send out multiple requests to the same credit/debit company in one bulk transaction.

As used herein, the term vending machine refers to any device or system capable of providing goods or services without the need for an attendant, including by way of non-limiting example, business work stations, customer actuated food and/or beverage dispensers, photo kiosks, DVD rental/sales devices, and gaming devices.

One or more of the functions of the various components described above may be implemented in software that controls a computer. This software may be embodied in a computer readable storage medium. Examples of computer readable storage mediums include, by way of non-limiting examples, a magnetic disk, an optical disk, a memory-card or other tangible medium capable of storing instructions.

Although the invention is illustrated and described herein with reference to specific embodiments, the invention is not intended to be limited to the details shown. Rather, various modifications may be made in the details within the scope and range of equivalents of the claims and without departing from the invention.

What is claimed:

1. A peripheral device for use with a vending machine having a vending machine controller, at least one other peripheral device, and a bus interconnecting the vending machine controller and the at least one other peripheral device, the peripheral device comprising:
a bus interface configured to receive data from the bus and to transmit data onto the bus; and
a processor coupled to the bus interface, the processor configured to enable cashless payment for the vending machine and to collect diagnostic information from the at least one other peripheral device based on data received from the at least one other peripheral device via the at least one bus interface over the bus.

2. The peripheral device of claim 1, wherein the at least one other peripheral device is configured to receive and store currency and to provide a storage capacity indicator onto the bus for collection by the processor.

3. The peripheral device of claim 1, wherein the processor is further configured to analyze the data from the at least one other peripheral device.

4. The peripheral device of claim 3, wherein the processor is further configured to transmit the analyzed data to a location remote from the vending machine.

5. The peripheral device of claim 3, wherein the processor is configured to analyze the collected data by:
(a) comparing the data from the at least one other peripheral device with a defined threshold, and
(b) if a result of the comparison indicates that the data from the at least one other peripheral device has a predefined relationship to the defined threshold, triggering an event.

6. The peripheral device of claim 5, wherein the processor is further configured to transmit the analyzed data to a location remote from the vending machine if the event is triggered.

7. The peripheral device of claim 1, wherein the bus interface includes a cashless payment interface and a diagnostic collection interface.

8. The peripheral device of claim 7, wherein the processor includes a first transceiver configured to communicate with the cashless payment interface and a second transceiver configured to communicate with the diagnostic collection interface.

9. The peripheral device of claim 7, wherein the processor includes a transceiver and the bus interface further includes a multiplexer, the multiplexer being configured to multiplex data received from the cashless payment interface and the diagnostic collection interface to the transceiver.

10. The peripheral device of claim 1, wherein the processor is configured to provide a state of operability of the at least one other peripheral device.

11. The peripheral device of claim 10, wherein:
the at least one other peripheral device is configured to provide an operability indicator onto the bus indicating whether the at least one other peripheral device is operable, respectively, and
the processor is configured to provide the state of operability of the peripheral device by receiving, storing and transmitting the operability indicator to a location remote from the vending machine.

12. The peripheral device of claim 1, further comprising a transmitter coupled to the processor, the processor being configured to transmit cashless payment information and diagnostic information to a remote processing unit via the transmitter.

13. The peripheral device of claim 1, wherein the bus interface is a multi-drop bus interface.

14. The peripheral device of claim 1, wherein the bus interface is a universal serial bus interface.

15. The peripheral device of claim 1, wherein the processor is further configured to collect diagnostic information from at least one vending machine sensor.

16. The peripheral device of claim 15, wherein the at least one vending machine sensor is selected from the group consisting of a temperature sensor, a power failure sensor, and an open door sensor.

17. A method of communicating with a vending machine having a vending machine controller, the method comprising:
monitoring a bus;
identifying a diagnostic communication via the monitored bus from the vending machine controller addressed to a peripheral device;
identifying via the monitored bus a response to the communication from the peripheral device to the vending machine controller;
associating the response with the peripheral device;
storing the response associated with the peripheral device; and
transmitting the stored response to a remote processing unit.

18. The method of claim 17, further comprising identifying via the monitored bus a cashless payment communication from the vending machine controller and responding to the cashless payment communication.

19. The method of claim 18, wherein the response to the communication from the peripheral device and the cashless payment communication are received via a common transceiver.

20. The method of claim 19, further comprising multiplexing the diagnostic communication and the response such that each of the diagnostic communication and the response is received by the common transceiver.

21. The method of claim 17, further comprising the step of:
analyzing the response from the peripheral device.

22. A vending system comprising:
a controller configured to control the vending system;
at least one peripheral device;
a bus interconnecting the control means and the at least one other peripheral device;
a bus interface configured to receive data from the bus means and transmit data onto the bus means; and
a processor coupled to the bus interface means configured to enable cashless payment for the vending system and to provide diagnostic information for the at least one peripheral device based on data from the at least one peripheral device received via the bus interface over the bus.

23. The system of claim 22, wherein the bus is a multi-drop bus.

24. The system of claim 22, wherein the bus is a USB.

25. The system of claim 22, wherein the bus interface includes a cashless payment interface and a diagnostic collection interface.

26. The system of claim 25, wherein the processor includes a first transceiver configured to communicate with the cashless payment interface and a second transceiver configured to communicate with the diagnostic collection interface.

27. The system of claim 25, wherein the processor includes a transceiver configured to receive data from the bus interface and the bus interface further includes a multiplexor configured to multiplex data received from the cashless payment interface and the diagnostic collection interface to the transceiver.

28. A computer readable storage medium including software that is adapted to control a computer to implement a method of communicating with a vending machine having a vending machine controller, the method comprising:
monitoring a bus;
identifying a diagnostic communication via the monitored bus from the vending machine controller addressed to a peripheral device;
identifying via the monitored bus a response to the communication from the peripheral device to the vending machine controller;
associating the response with the peripheral device;
storing the response associated with the peripheral device; and
transmitting the stored response to a remote processing unit.
